(19) United States
(12) Patent Application Publication
(10) Pub. No.: US 2020/0309394 A1
(43) Pub. Date: Oct. 1, 2020

(54) HVAC UNIT UTILIZING SELECTIVELY MODULATED FLOW RATES WITH HOT GAS REHEAT CIRCUIT

(71) Applicant: Johnson Controls Technology Company, Auburn Hills, MI (US)

(72) Inventor: Norman J. Blanton, Norman, OK (US)

(21) Appl. No.: 16/370,292

(22) Filed: Mar. 29, 2019

Related U.S. Application Data
(60) Provisional application No. 62/824,173, filed on Mar. 26, 2019.

(51) Int. Cl. F24F 3/153; F24F 3/14; F24F 11/83; F16K 11/00; F25B 45/00

(52) U.S. Cl. CPC F24F 3/153; F24F 3/1405; F24F 2003/144; F16K 11/00; F25B 45/00; F24F 11/83

(57) ABSTRACT

The present disclosure is directed to a single compressor HVAC system with hot gas reheat. The system includes a single compressor, at least one condenser, a reheat heat exchanger, an evaporator, and an expansion device. The HVAC system is designed to selectively modulate flow rates of refrigerant from the compressor between the at least one condenser and the reheat heat exchanger using a multi-directional valve, such as a three-way valve, downstream of the compressor.

### CROSS REFERENCE TO RELATED APPLICATION

This application claims priority from and the benefit of U.S. Provisional Application Ser. No. 62/824,173, entitled “HVAC UNIT UTILIZING SELECTIVELY MODULATED FLOW RATES WITH HOT GAS REHEAT CIRCUIT,” filed Mar. 26, 2019, which is hereby incorporated by reference in its entirety for all purposes.

### BACKGROUND

The present disclosure relates generally to heating, ventilating, and air conditioning (HVAC) systems and, more particularly, to HVAC systems utilizing selectively modulated flow rates to hot gas reheat circuits.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A wide range of applications exists for HVAC systems. For example, residential, light commercial, commercial, and industrial systems are used to control temperatures and air quality in residences and buildings. Very generally, HVAC systems may include circulating a fluid, such as a refrigerant, through a closed loop between an evaporator where the fluid absorbs heat and a condenser where the fluid releases heat. The fluid flowing within the closed loop is generally formulated to undergo phase changes within normal operating temperatures and pressures of the system so that considerable quantities of heat can be exchanged by virtue of the latent heat of vaporization of the fluid.

HVAC units, such as air handlers, heat pumps, and air conditioning units, are used to provide heated, cooled, and/or dehumidified air to conditioned environments. Dehumidification may be desired on days when the temperature is cool and there is a relatively high humidity level, such as damp, rainy, spring and fall days. Further, certain spaces, such as refrigerator cases, locker rooms, food production lines, art galleries, and museums, may benefit from a relatively low humidity environment. Accordingly, it may be desirable to operate an HVAC system with a certain amount of reheating.

For example, in reheat modes, humidity may be removed by cooling and then reheating air that is provided to the conditioned space. The air can be reheated using electric or gas heat; however, these heating methods may be relatively costly. The air also can be reheated by passing the air over a reheat heat exchanger that circulates heated refrigerant from the closed loop of the HVAC system. However, when the refrigerant is circulated through the reheat heat exchanger, it may be difficult to maintain a consistent refrigerant charge level within the HVAC system. Further, additional equipment, such as a second compressor, may be desired when employing a reheat heat exchanger within a HVAC system.

### SUMMARY

This section provides a brief summary of certain embodiments described in the present disclosure to facilitate a better understanding of the present disclosure. Accordingly, it should be understood that this section should be read in this light and not to limit the scope of the present disclosure. Indeed, the present disclosure may encompass a variety of aspects not summarized in this section.

The present disclosure relates to a heating, ventilating, or air conditioning system that includes a compressor configured to compress a refrigerant to produce compressed refrigerant. The heating, ventilating, or air conditioning system also includes a multi-directional valve configured to receive the compressed refrigerant from the compressor, to direct a first portion of the compressed refrigerant to a first condenser configured to cool the compressed refrigerant to provide cooled refrigerant, and to direct a second portion of the compressed refrigerant to a reheat circuit. The heating, ventilating, or air conditioning system further includes an evaporator configured to receive the cooled refrigerant from the first condenser, to transfer heat from a fluid external to the evaporator to the refrigerant to cool the fluid and provide heated refrigerant prior to directing the heated refrigerant to the compressor. In addition, the heating, ventilating, or air conditioning system includes a reheat heat exchanger configured to receive the second portion of the compressed refrigerant from the reheat circuit, and to transfer heat from the compressed refrigerant to the fluid cooled by the evaporator. Furthermore, the heating, ventilating, or air conditioning system includes a controller configured to selectively modulate a proportion of the first and second portions of the compressed refrigerant directed by the multi-directional valve.

The present disclosure also relates to a heating, ventilating, or air conditioning system that includes a compressor configured to compress a refrigerant. The heating, ventilating, or air conditioning system also includes at least one condenser configured to condense the refrigerant. The heating, ventilating, or air conditioning system further includes an evaporator configured to evaporate the refrigerant from the at least one condenser prior to returning the refrigerant to the compressor. In addition, the heating, ventilating, or air conditioning system includes a reheat heat exchanger configured to transfer heat from the refrigerant to a fluid cooled by the evaporator. Furthermore, the heating, ventilating, or air conditioning system includes a multi-directional valve configured to receive the refrigerant from the compressor, to direct a first portion of the refrigerant into the at least one condenser, and to direct a second portion of the refrigerant into the reheat heat exchanger. The heating, ventilating, or air conditioning system also includes a controller configured to selectively modulate the first and second portions of the refrigerant that is directed by the multi-directional valve.

The present disclosure also relates to a method for operating a heating, ventilating, or air conditioning system includes receiving a refrigerant flow from a compressor into a multi-directional valve. The method also includes directing a first portion of the refrigerant flow to a first condenser using the multi-directional valve. The method further includes directing a second portion of the refrigerant flow to a reheat heat exchanger using the multi-directional valve. In addition, the method includes controlling the multi-directional valve to selectively modulate the first and second portions of the refrigerant flow.

### BRIEF DESCRIPTION OF THE DRAWINGS

Various aspects of the present disclosure may be better understood upon reading the detailed description and upon reference to the drawings, in which:

FIG. 1 is a partial cross-sectional view of an embodiment of a building that includes a heating, ventilation, and/or air conditioning (HVAC) system, in accordance with aspects of the present disclosure;

FIG. 2 is a partial cross-sectional view of an embodiment of a packaged HVAC unit, in accordance with aspects of the present disclosure;

FIG. 3 is a partial cross-sectional view of an embodiment of a split, residential HVAC system, in accordance with aspects of the present disclosure;

FIG. 4 is a schematic diagram of an embodiment of a vapor compression system that may be incorporated with an HVAC system, in accordance with aspects of the present disclosure;

FIG. 5 is a schematic diagram of an HVAC unit, in accordance with aspects of the present disclosure;

FIG. 6 is a schematic diagram of another HVAC unit, in accordance with aspects of the present disclosure;

FIG. 7 is a block diagram of a method of operation of an HVAC unit, in accordance with aspects of the present disclosure; and

FIG. 8 is a schematic diagram of a controller configured to control operation of an HVAC unit, in accordance with aspects of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to an HVAC system that employs a novel hot gas reheat configuration to provide humidity control. The HVAC system includes a single compressor, at least one condenser, a reheat heat exchanger, an evaporator, and an expansion device. The HVAC system is designed to selectively modulate flow rates of refrigerant from the compressor between the at least one condenser and the reheat heat exchanger using a multi-directional valve, such as a three-way valve, downstream of the compressor. Modulating the flow of compressed refrigerant between the at least one condenser and the reheat heat exchanger facilitates greater control over the characteristics, such as normal humidification vs. dehumidification, of the conditioned air, while also maintaining loads on the single compressor, the at least one condenser, and the evaporator, among other components of the HVAC system, within reasonable operating ranges. As used here, the term “downstream” with respect to a point of reference is intended to mean a direction along a flow path in front of the point of reference in the direction of flow, whereas the term “upstream” with respect to a point of reference is intended to mean a direction along the flow path behind the point of reference in the direction of flow.

The HVAC system includes a closed refrigeration loop that circulates the refrigerant through the system. Within the system, the refrigerant exiting the compressor is separated into at least two portions. For example, first and second portions of the refrigerant are divided between flow paths of the closed refrigeration loop to the at least one condenser and the reheat heat exchanger, respectively. The condensed refrigerant from the at least one condenser is then directed through an expansion device and an evaporator to produce cooled air that is provided to the conditioned space. In addition, the portion of the refrigerant directed to the reheat heat exchanger heats air cooled by the evaporator, and then is combined with the condensed refrigerant from the at least one condenser and directed through the evaporator. In certain embodiments, the at least one condenser may include first and second condensers in parallel with each other. In such embodiments, a third portion of the refrigerant from the compressor may be directed to a first condenser downstream of the compressor but upstream of the multi-directional valve.

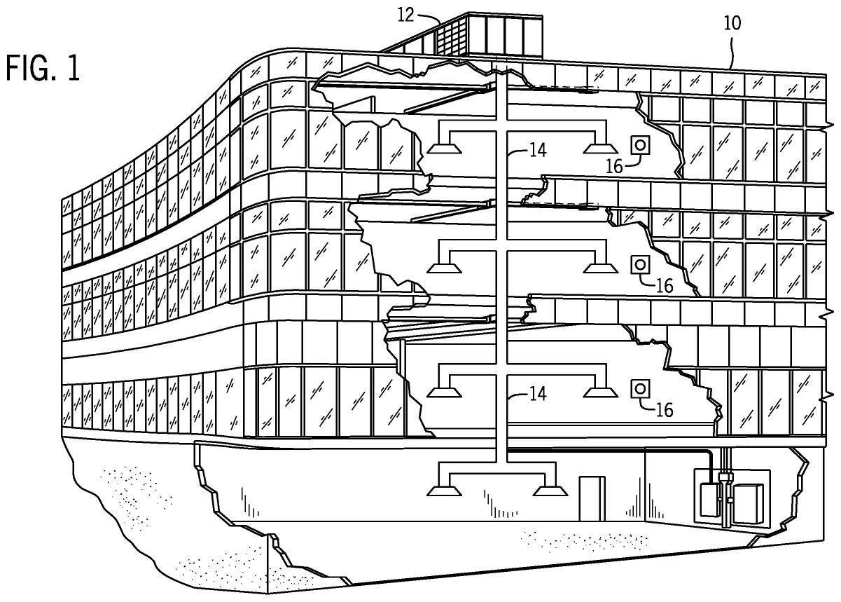

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

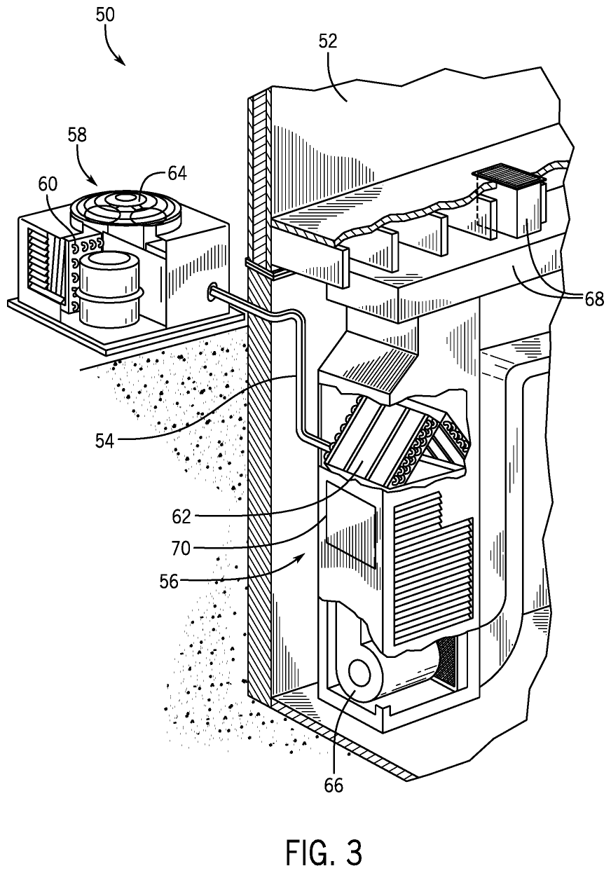

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

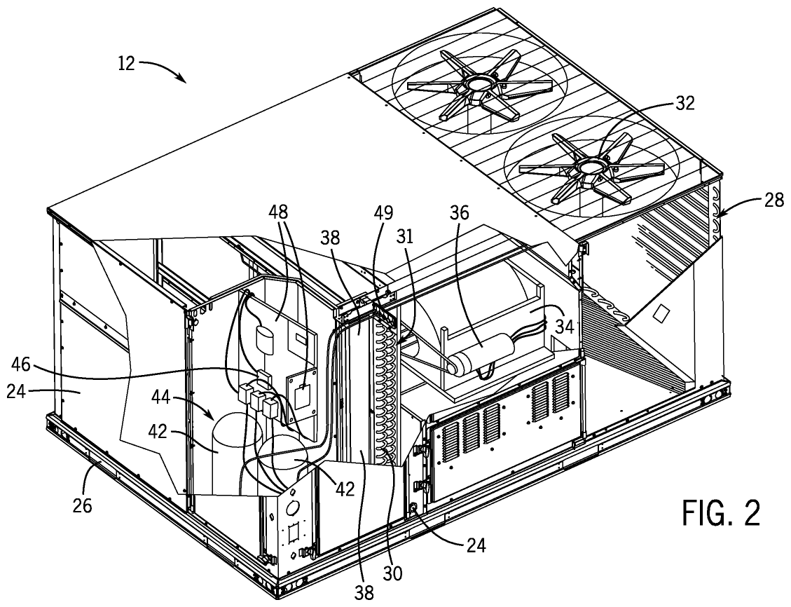

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the HVAC unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit 56 functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or a set point plus a small amount, the residential heating and cooling system 50 may become operative to refrigerate additional air for circulation through the residence 52. When the temperature reaches the set point, or a set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace system 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

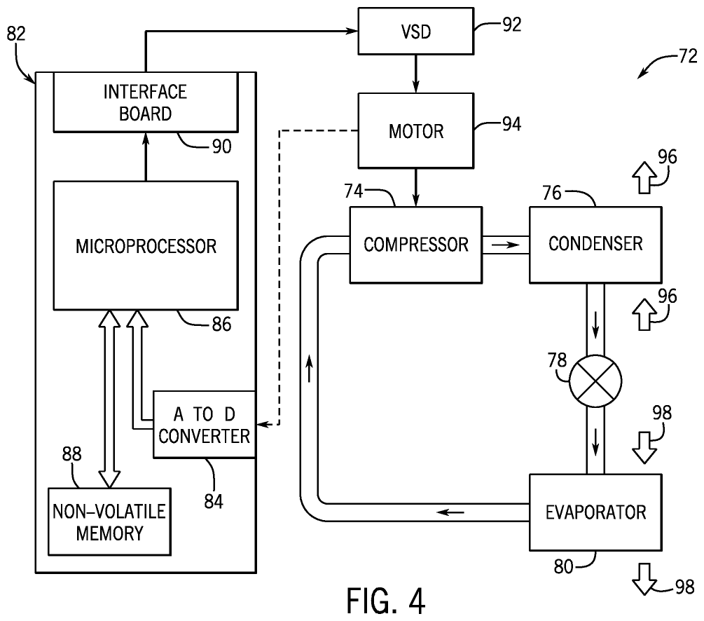

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

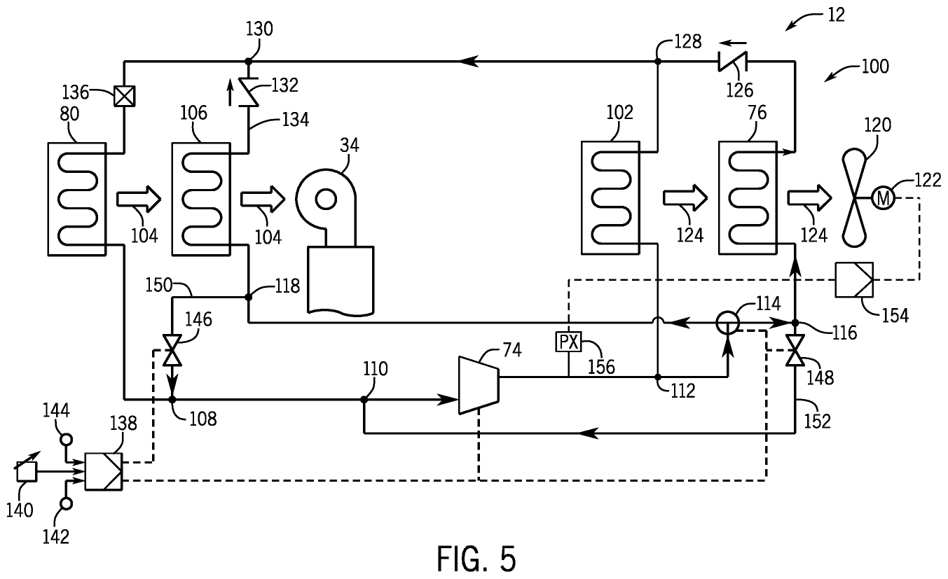

FIG. 5 is a schematic diagram that depicts the flow of refrigerant through the HVAC unit 12. As illustrated, refrigerant flows through the HVAC unit 12 within a closed refrigeration loop 100 wherein a refrigerant flows through an evaporator 80, a compressor 74, and at least one condenser 76, among other components of the HVAC unit 12. As illustrated in FIG. 5, in certain embodiments, the closed refrigeration loop 100 may include a first condenser 76 fluidly coupled with a second condenser 102 in parallel. However, as described in greater detail herein, in other embodiments, a single condenser 76 may be used. In certain embodiments, a blower assembly 34 draws air 104 through the evaporator 80. As the air 104 flows across the evaporator 80, the refrigerant flowing through the evaporator 80 absorbs heat from the air 104 to cool the air 104. The cooled air 104 may then be provided to the conditioned space through, for example, ductwork 14, 68. As the air 104 is cooled, moisture also may be removed from the air 104 to dehumidify the air 104. For example, as the air 104 flows across heat exchanger tubes of the evaporator 80, moisture within the air 104 may condense on the tubes, and may be directed to a drain, for example.

In certain embodiments, the blower assembly 34 also may draw the air 104 across a reheat heat exchanger 106, which is disposed generally downstream of the evaporator 80 with respect to the flow of the air 104 and, accordingly, the cooled air 104 exiting the evaporator 80 may flow through the reheat heat exchanger 106.

As the air 104 flows through the evaporator 80, the air 104 transfers heat to the refrigerant flowing within the evaporator 80. As the refrigerant is heated, at least a portion of, or a large portion of, the refrigerant may evaporate into a vapor. The heated refrigerant exiting the evaporator 80 then flows through connection points 108, 110 to enter the suction side of the compressor 74, which reduces the volume available for the refrigerant vapor, consequently, increasing the pressure and temperature of the refrigerant.

The refrigerant exits the discharge side of the compressor 74 as a high pressure and temperature vapor that flows to a connection point 112, where the refrigerant is split into two separate portions. In particular, a first portion of the refrigerant is directed to the condenser 102, and a second portion of the refrigerant is directed to a multi-directional valve 114, such as a three-way valve, where the refrigerant is again split into two separate portions. In particular, a first portion of the refrigerant is directed through a connection point 116 to the condenser 76, and a second portion of the refrigerant is directed through a connection point 118 to the reheat heat exchanger 106. As illustrated, in certain embodiments, the multi-directional valve 114 is located downstream of the connection point 112 and upstream of the condenser 76.

As such, the multi-directional valve 114 ensures that at least a portion of the second portion of the refrigerant from the connection point 112 is directed to the reheat heat exchanger 106, and that at least a portion of the second portion of the refrigerant from the connection point 112 is directed to the condenser 76. Specifically, the multi-directional valve 114 is configured to direct any and all proportions of the second portion of the refrigerant from the connection point 112 to either the reheat heat exchanger 106 or the condenser 76. For example, any conceivable percentage from 0% to 100% of the flow of the second portion of the refrigerant from the connection point 112 may be directed by the multi-directional valve 114 to the reheat heat exchanger 106, with the remainder of the flow of the second portion of the refrigerant from the connection point 112 being directed by the multi-directional valve 114 to the condenser 76. In addition, as described in greater detail herein, a controller may determine the exact proportion of the second portion of the refrigerant received from the connection point 112 that the multi-directional valve 114 should divide between the separate flow paths of the closed refrigeration loop 100 to the reheat heat exchanger 106 and the condenser 76. For example, as described in greater detail herein, a controller may selectively modulate the flow rates between the reheat heat exchanger 106 and the condenser 76 in substantially real time, such as during operation of the HVAC unit 12, based at least in part on temperature, pressure, and/or humidity values that are detected by various sensors disposed within the HVAC unit 12 itself and/or within a conditioned environment surrounding the HVAC unit 12.

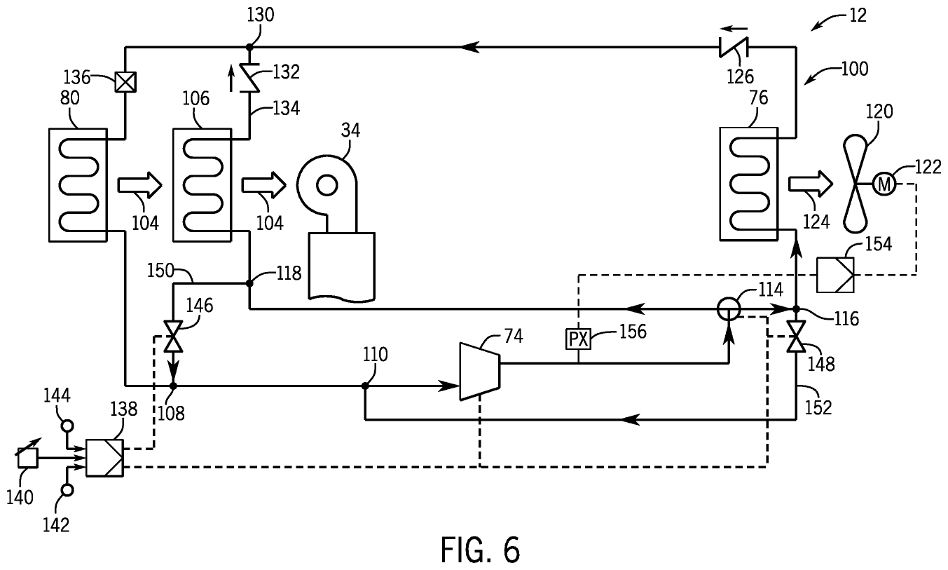

In the embodiment illustrated in FIG. 5, the refrigerant is separated into two portions at the connection point 112, with each portion flowing toward a separate condenser 76 or 102 in parallel. However, again, as described in greater detail herein with reference to FIG. 6, in other embodiments, the second condenser 102 and, thus, the connection point 112, may not be used. In certain embodiments, the condensers 76, 102 may be of approximately equal volume and/or size, allowing approximately half of the refrigerant by volume to be directed through each condenser 76, 102 in certain circumstances. Further, the use of two separate condensers 76, 102 may be designed to maximize the surface area that is available for heat transfer.

One or more fans 120, which are driven by one or more motors 122, draw air 124 across the condensers 76, 102 to cool the refrigerant flowing within the condensers 76, 102. According to certain embodiments, the motor 122 may be controlled by a variable speed drive (VSD) or variable frequency drive (VFD) that can adjust the speed of the motor 122, and thereby adjust the speed of the fans 120. The fans 120 may push or pull air across heat exchanger tubes of the condensers 76, 102. As the air 124 flows across the tubes of the condensers 76, 102, heat transfers from the refrigerant vapor to the air 124, producing heated air 124 and causing the refrigerant vapor to condense into a liquid. The refrigerant exiting the condenser 76 then flows through a check valve 126 to a connection point 128 where the refrigerant is combined with the refrigerant exiting the condenser 102. In certain embodiments, the check valve 126 may be designed to allow unidirectional flow within the closed refrigeration loop 100 in the direction from the condenser 76 to the connection point 128. In other words, in certain embodiments, the check valve 126 may impede the flow of refrigerant from the connection point 128 back into the condenser 76.

The condensed refrigerant from the condensers 76, 102 may then flow through a connection point 130. In certain embodiments, a check valve 132 inhibits the flow of refrigerant from the connection point 130 into a reheat circuit 134 that includes the reheat heat exchanger 106 to heat air 104 exiting the evaporator 80. Accordingly, in certain embodiments, the refrigerant flows from the connection point 130 to an expansion device 136, where the refrigerant expands to become a low pressure and temperature liquid. In certain embodiments, some vapor also may be present after expansion in the expansion device 136. In certain embodiments, the expansion device 136 may be a thermal expansion valve. However, in other embodiments, the expansion device 136 may be an electromechanical valve, an orifice, or a capillary tube, among others. Further, in other embodiments, multiple expansion devices 136 may be employed. For example, in certain embodiments, the refrigerant exiting the condenser 76 may be expanded in a first expansion device 136, while the refrigerant exiting the condenser 102 may be expanded in another expansion device 136. In these embodiments, the refrigerant may be combined downstream of the expansion devices 136 and upstream of the evaporator 80. From the expansion device 136, the refrigerant then enters the evaporator 80, where the low temperature and pressure refrigerant may then, once again, absorb heat from the air 104.

In certain embodiments, the operation of the HVAC unit 12 may be governed by a controller 138. For example, in certain embodiments, the controller 138 may transmit control signals to the compressor 74, for example, to a motor 94 that drives the compressor 74, and to the multi-directional valve 114 to regulate operation of the HVAC unit 12. Although not illustrated in FIG. 5, in certain embodiments, the controller 138 also may be electrically coupled to the blower assembly 34 and/or the motor 122 such that the controller 138 may transmit control signals to them. In certain embodiments, the controller 138 may receive input from a thermostat 140, and sensors 142, 144, and may use information received from these devices to determine how to control operating parameters of the HVAC unit 12. For example, in certain embodiments, the controller 138 may be configured to selectively modulate the flow rates that are divided between the respective flow paths to the reheat heat exchanger 106 and the condenser 76 in substantially real time, such as during operation of the HVAC unit 12, based at least in part on feedback received from the thermostat 140 and/or the sensors 142, 144. Furthermore, in certain embodiments, the controller 138 may receive inputs from local or remote command devices, computer systems and processors, and mechanical, electrical, and electromechanical devices that manually or automatically set a temperature and/or humidity related set point for the HVAC unit 12.

In certain embodiments, the sensors 142, 144 may detect the temperature and the humidity, respectively, within the conditioned space and may provide data and/or control signals indicative of the temperature and humidity to the controller 138, which may then compare the temperature and/or humidity data received from the sensors 142, 144 to a set point received from the thermostat 140. For example, the controller 138 may determine whether the sensed temperature is higher than a temperature set point, and may control operating parameters of the compressor 74 and/or the multi-directional valve 114 based on the comparison. In addition, in certain embodiments, the controller 138 also may adjust operation of the blower assembly 34 and the motor 122.

The controller 138 may execute hardware or software control algorithms to govern operation of the HVAC unit 12. In certain embodiments, the controller 138 may include an analog to digital (A/D) converter, a microprocessor, a non-volatile memory, and one or more interface boards. For example, in certain embodiments, the controller 138 may include a primary control board that receives control signals and/or data from the thermostat 140 and the temperature sensor 142. The primary control board of the controller 138 may be employed to govern operation of the compressor 74 and the multi-directional valve 114, as well as other system components. The controller 138 also may include a reheat control board that receives data and/or control signals from the humidity sensor 144. In certain embodiments, the sensor 144 may be a dehumidistat. The reheat control board of the controller 138 may be employed to govern the position of the multi-directional valve 114, as well as other system components. However, in other embodiments, the configuration of the controller 138 may vary. Further, other devices may, of course, be included in the system, such as additional pressure and/or temperature transducers or switches that sense temperatures and pressures of the refrigerant, the heat exchangers, the inlet and outlet air, and so forth, and the controller 138 may control operation of the HVAC unit 12 based at least in part on feedback from these devices.

In certain embodiments, the controller 138 is also electrically coupled to valves 146, 148 of refrigerant recovery circuits 150, 152, which may be employed to recover refrigerant from the reheat heat exchanger 106 and the condenser 76, respectively. For example, in certain circumstances, the controller 138 may open the valve 148 to direct refrigerant from the condenser 76 through the connection point 116 and the valve 148 to the connection point 110, where the refrigerant may be directed to the suction side of the compressor 74. In addition, in certain circumstances, the controller 138 may open the valve 146 to drain refrigerant from the reheat heat exchanger 106 through the connection point 118 and the valve 146 to the connection point 108, where the refrigerant may be directed to the suction side of compressor 74. As such, in certain embodiments, both refrigerant recovery circuits 150, 152 may be connected to the suction side of the compressor 74 to draw refrigerant from the refrigerant recovery circuits 150, 152 back to the compressor 74.

In general, the refrigerant recovery circuits 150, 152 are designed to allow refrigerant from the reheat heat exchanger 106 or the condenser 76 to return to the compressor 74. The return of refrigerant to the compressor 74 may ensure that most, or all, of the refrigerant is circulated through the compressor 74. In certain embodiments, the controller 138 may cycle valve 146 or valve 148 on and off, or may leave valve 146 or valve 148 open to allow refrigerant from the reheat heat exchanger 106 or condenser 76 to return to the compressor 74. For example, in certain embodiments, the controller 138 may close valve 146 or valve 148 after a set amount of time.

In certain embodiments, the HVAC unit 12 also includes a control device 154 that may be employed to regulate pressure within the closed refrigeration loop 100. In certain embodiments, for example, the control device 154 may be designed to ensure that a minimum pressure differential is maintained across the expansion device 136. In addition, in certain embodiments, the control device 154 may be coupled to a pressure transducer 156 that detects the discharge pressure of the compressor 74. As described in greater detail herein, in certain embodiments, the multi-directional valve 114 may be selectively modulated to ensure that the discharge pressure detected by the pressure transducer 156, which may generally relate to the head pressure of the compressor 74, is held low enough to keep the HVAC unit 12 online. Specifically, in certain embodiments, by selectively routing the refrigerant between the condenser 76 and the reheat heat exchanger 106, the head pressure may be maintained at a relatively low level.

As illustrated, in certain embodiments, the pressure transducer 156 may be disposed in the closed refrigeration loop 100 between the compressor 74 and the connection point 112. However, in other embodiments, the pressure transducer 156 may be disposed in other suitable locations on the high-pressure side of refrigeration loop 100. For example, in certain embodiments, the pressure transducer 156 may be located between the compressor 74 and the multi-directional valve 114. In other embodiments, the pressure transducer 156 may be located between the check valve 126 and the expansion device 136 or between the condensers 76, 102 and the expansion device 136. Furthermore, in other embodiments, any suitable type of pressure sensors may be used. For example, in certain embodiments, the pressure sensors may include one or more pressure switches and/or relays. Moreover, in certain embodiments, the control device 154 may be integrated with the controller 138 such that the control device 154 and the controller 138 working in conjunction with each other control operation of the various components of the HVAC unit 12.

In certain embodiments, the control device 154 may receive data indicative of the discharge pressure of the compressor 74, and may adjust the relative flow rates through the multi-directional valve 114, as well as the speed of the condenser fan motor 122, to maintain the pressure within a desired range. For example, the control device 154 may transmit control signals to the motor 122 to increase or decrease the fan speed. Furthermore, in certain embodiments, the control device 154 may include a VSD or VFD that adjusts the speed of motor 122. In addition, in certain embodiments, the control device 154 also may be employed to maintain sufficient flow of refrigerant through the reheat heat exchanger 106. Furthermore, as described in greater detail herein, in certain embodiments, the control device 154 may be configured to selectively modulate the flow rates that are divided between the respective flow paths to the reheat heat exchanger 106 and the condenser 76 in substantially real time, such as during operation of the HVAC unit 12, based at least in part on feedback received from the pressure transducer 156 or other pressure sensors. For example, in certain embodiments, the control device 154 may be configured to selectively modulate the flow rates that are divided between the respective flow paths to the reheat heat exchanger 106 and the condenser 76 in substantially real time to ensure that the discharge pressure of the compressor 74, as detected by the pressure transducer 156, is maintained within a predetermined pressure range, for example, between a predetermined minimum pressure level and a predetermined maximum pressure level.

FIG. 6 is a schematic diagram that depicts the flow of refrigerant through the HVAC unit 12. The embodiment illustrated in FIG. 6 is substantially similar to the embodiment illustrated in FIG. 5, with the exception that only one condenser 76 is used in the HVAC unit 12 illustrated in FIG. 6. As such, in the embodiment illustrated in FIG. 6, the refrigerant that exits the discharge side of the compressor 74 as a high pressure and temperature vapor flows directly into the multi-directional valve 114, where the refrigerant is split into two separate portions, similar to the embodiment illustrated in FIG. 5. In particular, similar to the embodiment illustrated in FIG. 5, a first portion of the refrigerant received by the multi-directional valve 114 from the compressor 74 is directed through the connection point 116 to the condenser 76, and a second portion of the refrigerant received by the multi-directional valve 114 from the compressor 74 is directed through the connection point 118 to the reheat heat exchanger 106. In this embodiment, however, since there is no additional refrigerant flow to a second condenser 102, all of the refrigerant that flows through the multi-directional valve 114 is either directed to the reheat heat exchanger 106 or the condenser 76.

As such, similar to the embodiment illustrated in FIG. 5, the multi-directional valve 114 illustrated in FIG. 6 ensures that at least a portion of the refrigerant received from the compressor 74 is directed to the reheat heat exchanger 106, and that at least a portion of the refrigerant received from the compressor 74 is directed to the condenser 76. Specifically, the multi-directional valve 114 is configured to direct any proportion of the refrigerant received from the compressor 74 to either the reheat heat exchanger 106 or the condenser 76. For example, any percentage from 0% to 100% of the flow of the refrigerant received from the compressor 74 may be directed by the multi-directional valve 114 to the reheat heat exchanger 106, whereas the remainder of the flow of the refrigerant received from the compressor 74 may be directed by the multi-directional valve 114 to the condenser 76. As described in greater detail herein, the controller 138 may determine the exact proportion of the refrigerant received from the compressor 74 that the multi-directional valve 114 should divide between the separate flow paths of the closed refrigeration loop 100 to the reheat heat exchanger 106 and the condenser 76. For example, as described in greater detail herein, the controller 138 may selectively modulate the flow rates between the reheat heat exchanger 106 and the condenser 76 based at least in part on temperature, pressure, and/or humidity values that are detected by various components, such as the thermostat 140, the sensors 142, 144, the pressure transducer 156, and/or other sensors, disposed within the HVAC unit 12 itself and/or within a conditioned environment surrounding the HVAC unit 12. For example, in certain embodiments, the controller 138 may be configured to selectively modulate the multi-directional valve 114 to maintain the discharge pressure of the compressor 74, for example, as detected by the pressure transducer 156, below a predetermined maximum pressure level, above a predetermined minimum pressure level, or within a predetermined range of desirable pressures.

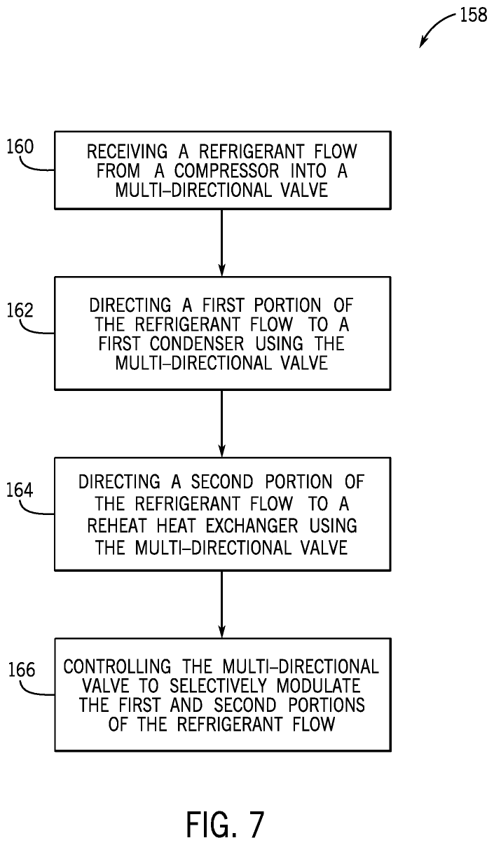

FIG. 7 is a block diagram of a method 158 of operation of the HVAC unit 12. As illustrated, in certain embodiments, the method 158 includes receiving a refrigerant flow from a compressor 74 into a multi-directional valve 114 (block 160). In addition, in certain embodiments, the method 158 includes directing a first portion of the refrigerant flow to a first condenser 76 using the multi-directional valve 114 (block 162). In addition, in certain embodiments, the method 158 includes directing a second portion of the refrigerant flow to a reheat heat exchanger 106 using the multi-directional valve 114 (block 164). In addition, in certain embodiments, the method 158 includes controlling the multi-directional valve 114 to selectively modulate the first and second portions of the refrigerant flow (block 166).

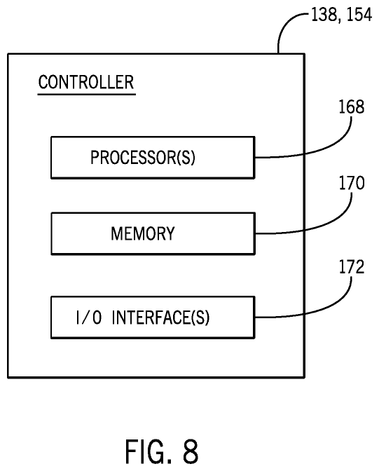

FIG. 8 is a schematic diagram of a controller, such as the controller 138 and/or the control device 154, configured to control operation of an HVAC unit 12. As described in greater detail herein, the controller 138, 154 may be configured to control various operating parameters of the HVAC unit 12 including, but not limited to, selectively modulating the flow of refrigerant through the multi-directional valve 114 between the condenser 76 and the reheat heat exchanger 106, for example, as described with respect to FIG. 7, as well as controlling operating parameters of the compressor 74 such as discharge pressure, discharge flow rates, and so forth, operating parameters of the motor 122 such as motor speed, air flow rate, and so forth, operating parameters of the blower assembly 34 such as blower speed, air flow rate, and so forth, and other operating parameters of the HVAC unit 12. As also described in greater detail herein, the controller 138, 154 may be configured to control various operating parameters of the HVAC unit 12 based at least in part on feedback from various components, such as the thermostat 140, the sensors 142, 144, the pressure transducer 156, and/or other sensors, disposed within the HVAC unit 12 itself and/or within a conditioned environment surrounding the HVAC unit 12. For example, in certain embodiments, the controller 138, 154 may be configured to selectively modulate the multi-directional valve 114 to maintain the discharge pressure of the compressor 74, for example, as detected by the pressure transducer 156, below a predetermined maximum pressure level, above a predetermined minimum pressure level, or within a predetermined range of desirable pressures.

As illustrated in FIG. 8, in certain embodiments, the controller 138, 154 may include one or more processors 168, one or more memory devices 170, such as a non-transitory machine readable media, and/or one or more input/output (I/O) interfaces 172, which may be configured to communicate with the various components of the HVAC unit 12 described herein. Furthermore, in certain embodiments, the controller 138, 154 may be implemented as part of the control panel 82, or may be implemented separately as stand-alone circuitry.

While only certain features and embodiments of the disclosure have been illustrated and described, many modifications and changes may occur to those skilled in the art, such as variations in sizes, dimensions, structures, shapes and proportions of the various elements, values of parameters, including temperatures and pressures, mounting arrangements, use of materials, colors, orientations, and so forth without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosure, or those unrelated to enabling the claimed disclosure. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilating, or air conditioning system comprising:
a compressor configured to compress a refrigerant to produce compressed refrigerant;
a multi-directional valve configured to receive the compressed refrigerant from the compressor, to direct a first portion of the compressed refrigerant to a first condenser configured to cool the compressed refrigerant to provide cooled refrigerant, and to direct a second portion of the compressed refrigerant to a reheat circuit;
an evaporator configured to receive the cooled refrigerant from the first condenser, to transfer heat from a fluid external to the evaporator to the refrigerant to cool the fluid and provide heated refrigerant prior to directing the heated refrigerant to the compressor;
a reheat heat exchanger configured to receive the second portion of the compressed refrigerant from the reheat circuit, and to transfer heat from the compressed refrigerant to the fluid cooled by the evaporator; and
a controller configured to selectively modulate a proportion of the first and second portions of the compressed refrigerant directed by the multi-directional valve.

2. The heating, ventilating, or air conditioning system of claim 1, wherein the controller is configured to selectively modulate the proportion of the first and second portions of the compressed refrigerant based on feedback from at least one sensor.

3. The heating, ventilating, or air conditioning system of claim 2, wherein the at least one sensor comprises a pressure sensor configured to detect a pressure of the heating, ventilating, or air conditioning system.

4. The heating, ventilating, or air conditioning system of claim 2, wherein the at least one sensor comprises a temperature sensor configured to detect a temperature of the heating, ventilating, or air conditioning system.

5. The heating, ventilating, or air conditioning system of claim 1, comprising a second condenser in parallel with the first condenser.

6. The heating, ventilating, or air conditioning system of claim 5, wherein the multi-directional valve is disposed upstream of a first inlet connection to the first condenser with respect to a direction of flow of the compressed refrigerant, and downstream of a second inlet connection to the second condenser with respect to the direction of flow of the compressed refrigerant.

7. The heating, ventilating, or air conditioning system of claim 5, comprising a refrigerant recovery circuit configured to direct refrigerant from the first condenser to a suction side of the compressor.

8. The heating, ventilating, or air conditioning system of claim 1, comprising at least one expansion device configured to receive and to reduce pressure of the cooled refrigerant from the first condenser.

9. The heating, ventilating, or air conditioning system of claim 8, wherein the expansion device is configured to receive refrigerant from the reheat heat exchanger.

10. A heating, ventilating, or air conditioning system comprising:
a compressor configured to compress a refrigerant;
at least one condenser configured to condense the refrigerant;
an evaporator configured to evaporate the refrigerant from the at least one condenser prior to returning the refrigerant to the compressor;
a reheat heat exchanger configured to transfer heat from the refrigerant to a fluid cooled by the evaporator;
a multi-directional valve configured to receive the refrigerant from the compressor, to direct a first portion of the refrigerant into the at least one condenser, and to direct a second portion of the refrigerant into the reheat heat exchanger; and
a controller configured to selectively modulate the first and second portions of the refrigerant that is directed by the multi-directional valve.

11. The heating, ventilating, or air conditioning system of claim 10, wherein the controller is configured to selectively modulate the first and second portions of the refrigerant based on feedback from at least one sensor.

12. The heating, ventilating, or air conditioning system of claim 10, wherein the at least one condenser comprises first and second condensers in parallel with each other.

13. The heating, ventilating, or air conditioning system of claim 12, wherein the multi-directional valve is disposed downstream of an inlet connection to the first condenser and upstream of the second condenser with respect to flow of the refrigerant.

14. The heating, ventilating, or air conditioning system of claim 12, comprising a refrigerant recovery circuit configured to direct refrigerant from the second condenser to a suction side of the compressor.

15. The heating, ventilating, or air conditioning system of claim 10, comprising at least one expansion device configured to receive and to reduce pressure of the refrigerant from the at least one condenser.

16. The heating, ventilating, or air conditioning system of claim 15, wherein the expansion device is configured to receive the refrigerant from the reheat heat exchanger.

17. A method for operating a heating, ventilating, or air conditioning system, comprising:
receiving a refrigerant flow from a compressor into a multi-directional valve;
directing a first portion of the refrigerant flow to a first condenser using the multi-directional valve;
directing a second portion of the refrigerant flow to a reheat heat exchanger using the multi-directional valve;
controlling the multi-directional valve to selectively modulate the first and second portions of the refrigerant flow.

18. The method of claim 17, comprising determining a proportion of the first portion of the refrigerant flow relative to the second portion of the refrigerant flow, and controlling the multi-directional valve to selectively modulate the first and second portions of the refrigerant flow based at least in part of the proportion.

19. The method of claim 18, wherein determining the proportion of the first portion of the refrigerant flow relative to the second portion of the refrigerant flow is based at least in part on feedback from at least one sensor.

20. The method of claim 17, comprising directing a third portion of the refrigerant flow to a second condenser upstream of the multi-directional valve.
